(19) United States
(12) Patent Application Publication
(10) Pub. No.: US 2022/0066818 A1
(43) Pub. Date: Mar. 3, 2022

(54) MULTIPLE TASK EXECUTION

(71) Applicant: FUJITSU LIMITED, Kawasaki-shi (JP)

(72) Inventors: Mehdi BAHRAMI, San Jose, CA (US); Nithya KUCHADI, Sunnyvale, CA (US); Wei-Peng CHEN, Fremont, CA (US); Oussama CHAFIQUI, Sunnyvale, CA (US)

(73) Assignee: FUJITSU LIMITED, Kawasaki-shi (JP)

(21) Appl. No.: 17/007,846

(22) Filed: Aug. 31, 2020

(51) Int. Cl. G06F 9/48; G06F 3/0486; G06F 9/50; G06F 9/54

(52) U.S. Cl. CPC G06F 9/4881; G06F 9/547; G06F 9/5038; G06F 3/0486

(57) ABSTRACT

A method may include obtaining multiple tasks. The multiple tasks may be configured to perform at least one function when executed. The method may also include obtaining an execution arrangement of a set of tasks of the multiple tasks. The execution arrangement may define when execution of functions of tasks of the set of tasks occur and may define data to be passed between at least two tasks of the set of tasks. The method may also include automatically generating a specification that includes a different object for each of the tasks of the set of tasks. The method may further include automatically generating executable code using the specification. The executable code may be configured to perform all the functions of all of the tasks of the set of tasks according to the execution arrangement based on a single user request.

### BACKGROUND

Tasks enable people to perform desired functions within a system. Some tasks contain functions that make calls to an application programming interfaces (APIs). APIs are a convenient mechanism by which functionality of a separate computing system may be accessed and/or invoked. For example, such functionality may be incorporated into a software project, accessed by a database, accessed by an Internet of things (IoT) device, etc.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

In an example embodiment, a method may include obtaining, by a system, multiple tasks. The multiple tasks may be configured to perform at least one function when executed. The method may also include obtaining an execution arrangement of a set of tasks of the multiple tasks. The execution arrangement may define when execution of functions of tasks of the set of tasks occur and may define data to be passed between at least two tasks of the set of tasks. The method may also include automatically generating a specification that includes a different object for each of the tasks of the set of tasks. Each of the objects may be modified during the generation of the specification based on the execution arrangement and the data. The method may further include automatically generating executable code using the specification. The executable code may be configured to perform all the functions of all of the tasks of the set of tasks according to the execution arrangement based on a single user request.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment for task execution;

FIG. 2 illustrates an example operational flow;

FIG. 3 illustrates an example graphical user interface for arranging tasks;

FIG. 4 is a block diagram illustrating a visualization of an example execution arrangement of a set of tasks;

FIG. 5 illustrates an example specification for an execution arrangement of multiple tasks;

FIG. 6 illustrates a flowchart of an example method of multiple task execution; and

FIG. 7 illustrates an example system.

### DESCRIPTION OF EMBODIMENTS

People have become accustomed to using computers and software to perform various tasks. For example, some tasks may include checking a calendar to verify availability for future meetings, creating and updating a spreadsheet with new data, drafting and sending emails, and querying a database for information. In some circumstances, execution of the tasks may include making one or more calls to application programming interfaces (APIs). In some cases, a person may desire to perform a substantial number of tasks and working through a single task at a time may result in a significant amount of time and effort.

As comfortable as people have become with instructing computers to perform tasks, the underlying code that enables a task to operate as expected is not familiar to many people that benefit from a given task. Furthermore, computer code that facilitates functional tasks may be written in many various computer programming languages that may be unfamiliar to people. Additionally, computer code may be written in such a nuanced manner that even people familiar with the coding language may have difficulty understanding the structure and function of the code. A person seeking to combine many tasks into a single task, in order to simplify operations, may experience increased issues as dealing with code of many tasks becomes increasingly complex with each additional task that is included.

Some embodiments in this disclosure relate to systems and/or methods that may be configured to obtain multiple tasks and allow a person to create a set of tasks that are chained together that may be combined into a single task. For example, a person without knowledge of software programming and/or coding may choose to combine a task to query a database and a task to update a spreadsheet based on data obtained from the query to the database. In some circumstances, the set of tasks may be regularly performed in concert by a person that may be seeking to integrate the set of tasks into a single task. Some embodiments in this disclosure may allow a person to arrange an execution order of the set of tasks and what data may be passed between the set of tasks using a graphical user interface. As such, the systems and/or methods described herein may obtain an execution arrangement of the set of tasks that may define when execution of the set of tasks may occur and data to be passed between at least two of the set of tasks.

In some embodiments, the systems and/or methods described in this disclosure may be configured to create a specification based on the execution arrangement of the set of tasks. The specification may be automatically generated after obtaining the execution arrangement for the set of tasks. The specification may include a different object for each task of the set of tasks. The objects may be modified during the generation of the specification based on the execution arrangement and the data to be passed between at least two tasks of the set of tasks.

In some embodiments, executable code may be automatically generated based on the information included within the specification. The executable code may be configured to perform all of the tasks of the set of tasks according to the execution arrangement based on a single request from a user. Thus, using the systems and methods described in this disclosure, a person without knowledge of software programming and/or coding and using a graphical user interface may combine tasks without writing code to implement the combination of the tasks.

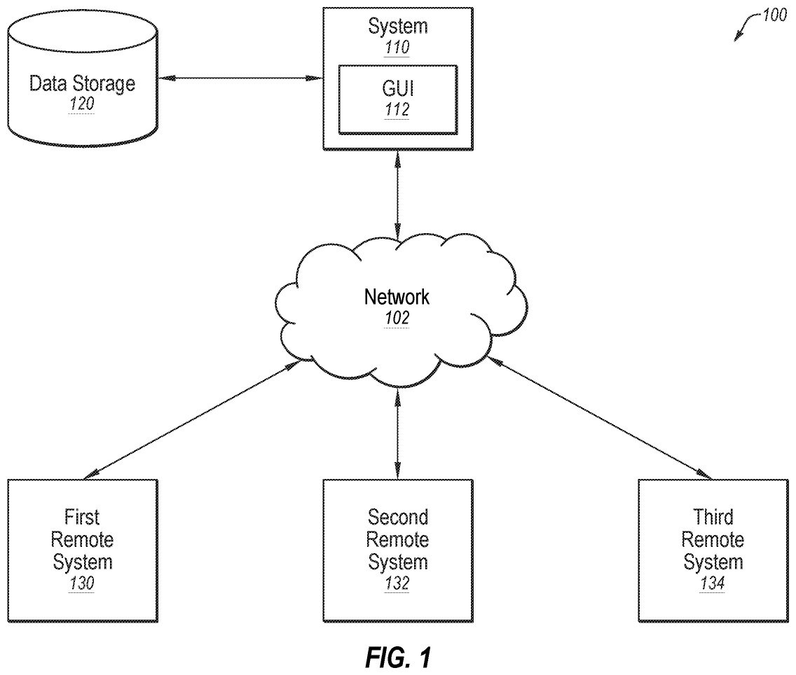

FIG. 1 illustrates an example environment 100 for task execution. The environment 100 may be arranged in accordance with at least one embodiment described in the present disclosure. The environment 100 may include a first network 102, a system 110 that includes a graphical user interface 112, data storage 120, a first remote system 130, a second remote system 132, and a third remote system 134.

The first network 102 may be configured to communicatively couple the system 110, the first remote system 130, a second remote system 132, and a third remote system 134. In some embodiments, the first network 102 may be any network or configuration of networks configured to send and receive communications between systems. In some embodiments, the first network 102 may include a wired network, an optical network, and/or a wireless network, and may have numerous different configurations, including multiple different types of networks, network connections, and protocols to communicatively couple systems in the environment 100.

Each of the system 110, the first remote system 130, the second remote system 132, and the third remote system 134 may be any electronic or digital computing device and/or system. For example, each of the system 110, the first remote system 130, the second remote system 132, and the third remote system 134 may include a desktop computer, a laptop computer, a smartphone, a mobile phone, a tablet computer, server, a processing system, or any other computing device that may be used for performing the operations described in this disclosure and for communicating data between the system 110, the first remote system 130, the second remote system 132, and the third remote system 134.

In some embodiments, each of the system 110, the first remote system 130, the second remote system 132, and the third remote system 134 may include memory and at least one processor, which are configured to perform operations as described in this disclosure, among other operations. In some embodiments, each of the system 110, the first remote system 130, the second remote system 132, and the third remote system 134 may include computer-readable instructions that are configured to be executed by each of the system 110, the first remote system 130, the second remote system 132, and the third remote system 134 to perform operations described in this disclosure.

In some embodiments, the system 110 may be configured to operate the graphical user interface 112. Operating the graphical user interface 112 may include executing instruction to cause the display of the graphical user interface 112, to receive inputs from a user, and to generate and display outputs. In some embodiments, the instructions to operate the graphical user interface 112 may be stored in the memory of the system 110.

In some embodiments, the system 110 and the data storage 120 may be communicatively coupled to allow data to be passed between the system 110 and the data storage 120. The data storage 120 may be configured to send tasks to the system 110 when requested by the system 110. In some embodiments, the data storage 120 may be configured to receive and store an integrated task that may be a chain of tasks sent from the system 110. Generally, the use of the term “task” in the disclosure without a qualifier such as “integrated” refers to an individual task. An integrated task may refer to a set of tasks that are chained together and integrated to form an integrated task.

In some embodiments, the communication link between the system 110 and the data storage 120 may be any configuration of networking elements configured to send and receive communications between the system 110 and the data storage 120. In these and other embodiments, data may be passed between the system 110 and the data storage 120 using methods common in digital data transfer. Such methods may include PCI, PCI Express, Ethernet, wireless transfer such as Bluetooth®, Wi-Fi, WiMAX, cellular communications, and the like.

The data storage 120 may be configured to store existing tasks and integrated tasks. The data storage 120 may also be configured to store newly created tasks and integrated tasks. The data storage 120 may include computer-readable storage media such as Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store data or data structures which may be accessed by a general-purpose or special-purpose computer.

In some embodiments, a task may be represented by a set of computer-readable instructions (e.g., programming code) that cause a computing system to implement a specific implementation of a function. In some embodiments, a task may have static elements, which elements may be necessary to operate the task. Alternatively or additionally, a task may have user-defined elements that may be received when a user invokes a task. In these and other embodiments, the user-defined elements may have placeholders until user-input is received. In some embodiments, a task may have outputs. In tasks that have outputs, the outputs may be displayed to a user, stored in the system that executed the task, passed to another task as an input, stored in a remote system, etc. Alternatively or additionally, a task may not have any output. In some embodiments, a task may have additional information, that may include a defined scope, an authorization type, and/or credentials, etc.

In some embodiments, tasks stored in the data storage 120 may be configured to perform functions that include making a call to an API. A task that makes a call to an API may be configured to use the call to the API to assist in performance of a specific implementation of a function. The function may relate to operations requested to be performed by a user that are defined functions of a program used by the user. For example, a user may desire to access the twenty-five most recent unread emails from an email service that permits an API service in accessing the email accounts. Continuing the example, a task may include programming code to identify what quantity of recent unread emails to obtain, invoke the API call to access the email service, and provide the results of the API call. In these and other embodiments, a task may be configured to make a call to an API to obtain information for an email event.

As another example, tasks stored in the data storage 120 may be configured to perform functions based on a function code of the tasks. In these and other embodiments, the tasks may also make a call to an API. In these and other embodiments, one or more of the tasks stored in the data storage 120 may be represented by programming code in different code languages. For example, a first task stored in the data storage 120 may be represented by programming code in a first language and a second task stored in the data storage 120 may be represented by programming code in a second language.

In some embodiments, a task may or may not involve user-input in the process. For example, a task may be configured to obtain calendar events over a time period specified by a user. In another example, a task may be configured to obtain all calendar events, not requiring any user input. In some embodiments, a task may make a call to an API of a remote system. For example, a task may be configured to make a call to an API of a remote server controlled by GOOGLE for a GOOGLE calendar event.

In some embodiments, a first task may include a function that may make a call to an API of the first remote system 130 and a second task may include a function that may make a call to an API of the second remote system 132 or may perform functions based on a function code of the second task. For example, a first task may include a function that may make a call to an API for a calendar event of the first remote system 130, and a second task may include a function that may make a call to an API for a calendar event of the second remote system 132. Alternatively or additionally, the API of the first task on the first remote system 130 may not correspond with the API of the second task on the second remote system 132. For example, a first task may include a function that may make a call to an API of a remote server controlled by GOOGLE for a GOOGLE calendar event and a second task may include a function that may make a call to an API of a remote server controlled by MICROSOFT for a MICROSOFT email event.

In some embodiments, some of the tasks in the data storage 120 may include a call to an API. In these and other embodiments, the tasks may include calls to APIs that are part of remote systems that are not associated and/or correlated. For example, some tasks may include calls to APIs of the first remote system 130. Other tasks may include calls to APIs of the second remote system 132. Further, other tasks may include calls to APIs of the third remote system 134. Although three remote systems are illustrated, the tasks may include calls to APIs of any number of remote systems. The first remote system 130, the second remote system 132, and the third remote system 134 may not be controlled nor operated by the same entity. Alternately or additionally, the APIs hosted by the first remote system 130, the second remote system 132, and the third remote system 134 may be associated or unassociated. For example, the API hosted by the first remote system 130 may involve a calendaring program and the API hosted by the second remote system 132 may involve an email program.

In some embodiments, a task may include a function that may make a call to an API of a first remote system 130 that uses authentication from a data storage unassociated with the first remote system 130. For example, a task may include a function that may make a call to an API for a calendar event tied to a user's GOOGLE account that uses an authentication token to access the GOOGLE account. The task may request authentication before the API may return the calendar event item.

In some embodiments, the system 110 may obtain an indication of some tasks or all of the tasks stored by the data storage 120. For example, the system 110 may request an indication of tasks from the data storage 120, and the data storage 120 may send the indication of tasks to the system 110.

In some embodiments, the system 110 may operate the graphical user interface 112 to obtain an execution arrangement of a set of the tasks from the data storage 120. For example, the system 110 may operate the graphical user interface 112 to display a listing of some or all of the tasks available in the data storage 120. The graphical user interface 112 may be configured to obtain input from a user that selects a set of tasks from the tasks displayed on the graphical user interface 112. In these and other embodiments, the graphical user interface 112 may be configured to obtain input from a user to arrange the set of tasks. In these and other embodiments, the graphical user interface 112 may be configured to obtain input from the user to define the order of execution of the functions of the set of tasks and the data that may be passed between the tasks of the set of tasks.

In some embodiments, an execution arrangement may be configured to direct the order of execution of the tasks of the set tasks and define dependencies between the tasks of the set to be executed. For example, a second task of the set of tasks that depends on the results of a first task of the set of tasks may result in a dependent sequential execution arrangement between the first task and the second task. In these and other embodiments, in the dependent sequential execution arrangement, the first task executes before the second task to generate outputs. After generation of the outputs, the second task executes and uses the generated output during execution. In another example, a second task of the set of tasks that does not depend on the results of a first task of the set of tasks but may be ordered to follow the first task, may result in an independent sequential execution arrangement between the first task and the second task. In these and other embodiments, in the independent sequential execution arrangement, the first task executes before the second task and may generate outputs. After the first task executes, the second task executes independent of the generated output of the first task. In another example, a first task and a second task of the set of tasks may not have any dependencies between them. Alternately or additionally, the first task and the second task may be executed during overlapping time periods and may result in a parallel execution arrangement between the first task and the second task. In these and other embodiments, the set of tasks may be a chain of tasks where the execution arrangement of the set of tasks may define the relationship between the tasks of the chain of tasks.

In some embodiments, the graphical user interface 112 may provide an environment that displays tasks as task graphical user interface objects. For example, each task in the system 110 may be represented by an object in the graphical user interface 112. In these and other embodiments, a user may select and arrange two or more of the task graphical user interface objects in the graphical user interface 112 to create the execution arrangement of the set of tasks. In some embodiments, the task graphical user interface objects may be dragged and dropped in the graphical user interface 112 to create the execution arrangement. For example, a first task graphical user interface object may be selected and dragged and dropped in the graphical user interface 112. After dragging and dropping the first task graphical user interface object, a second task graphical user interface object may be selected and dragged and dropped in the graphical user interface 112. After dragging and dropping the first and second task graphical user interface objects or while dragging and dropping the second task graphical user interface object, a user may arrange the first and second task graphical user interface objects in the graphical user interface spatially with respect to one another to indicate an execution arrangement that defines the order of execution of the functions of the first and second tasks. The execution arrangement may also define which tasks pass data to other tasks in the execution arrangement.

In some embodiments, after obtaining an execution arrangement of the set of tasks, the system 110 may automatically generate a specification. In these and other embodiments, a specification automatically generated by the system 110 may be generated based on the set of tasks in the execution arrangement and the execution arrangement of the set of tasks. In these and other embodiments, the specification may be generated to include different objects for each task in the execution arrangement. In some embodiments, the objects for the tasks in the specification may include a particular structure. The particular structure may include one or more variables. The particular structure and/or variables in the specification may be modified based on data passed between the tasks and the execution arrangement of the tasks. As an example, the variables of a particular structure of an object for a first task may be structured to store data that identifies a location and/or dependencies of the first task in the execution arrangement, store data pointing to an output of a second task for the first task to obtain data passed between the first task and the second task, and store data from inputs input from a user.

In some embodiments, after automatically generating a specification, the system 110 may automatically generate an integrated task using the specification. The integrated task may be configured to perform some or all of the functions of the tasks of the set of tasks with a single user input according to the execution arrangement. For example, two tasks, such as two tasks that communicate with different remote systems and are written in different programming languages may be integrated into a single integrated task in a common programming language based on an execution arrangement that specifies that the first task is performed first and provides its output to the second task. As a result, during execution of the single integrated task, the first task may be performed and the output of the first task may be used as an input of the second task. Previously, a user would have had to select the first task, review the output of the first task, select the second task, and input the output of the first task to the second task to obtain an output of the second task. After generation of the integrated task, selection of the integrated task by the user may result in the output of the second task being provided to the user with the user only having to select the integrated task. The integrated task may thus be a chaining and integration of the first and second tasks such that a single user input obtains output of the second task that is based on the output of the first task.

In some embodiments, the integrated task may be represented and performed by executable code. The integrated task may be generated without any additional input from a user. In some embodiments, the integrated task may be automatically generated in any programming language. Alternatively or additionally, the integrated task may be generated in more than one programming language. In some embodiments, an authentication token may be used in conjunction with the specification to automatically generate the integrated task. For example, a task with a function to make a call to an API of a remote system may request user authentication for the remote system. Continuing the example, a user may provide an authentication token to the system, that may be used in automatically generating executable code. In these and other embodiments, the integrated task e may be configured to use the authentication token to perform the task without further input from the user after selection of the integrated task.

In some embodiments, code snippets may be used with the specification, which defines the execution arrangement of the set of tasks, to automatically generate the executable code of the integrated task. For example, a first task with a function to obtain a calendar event may use a set of code snippets. A second task with a function to obtain all calendar events may use a second set of code snippets.

In some embodiments, specific rules may be associated with a task and may be used with the specification to automatically generate the executable code of the integrated task. For example, a task that has a constant as an input may use a first rule to automatically generate the executable code associated with the first task. Continuing the example, a second task that has a user-input as an input may use a second rule to automatically generate the executable code associated with the second task. Continuing the example, a third task that has a reference as an input may use a third rule to automatically generate executable code associated with the third task. Alternatively or additionally, automatically generated executable code may use combinations of the rules based on a task that has multiple inputs.

Modifications, additions, or omissions may be made to the environment 100 without departing from the scope of the present disclosure. For example, in some embodiments, the environment 100 may include not include the second remote system 132, or the third remote system 134. In these and other embodiments, the system 110 may have access to data from the first remote system 130. Alternatively or additionally, the environment 100 may not include any of the first remote system 130, the second remote system 132, or the third remote system 134. In these and other embodiments, the system 110 may have access to data without contacting a remote system. As another example, the system 110 may include the data storage 120.

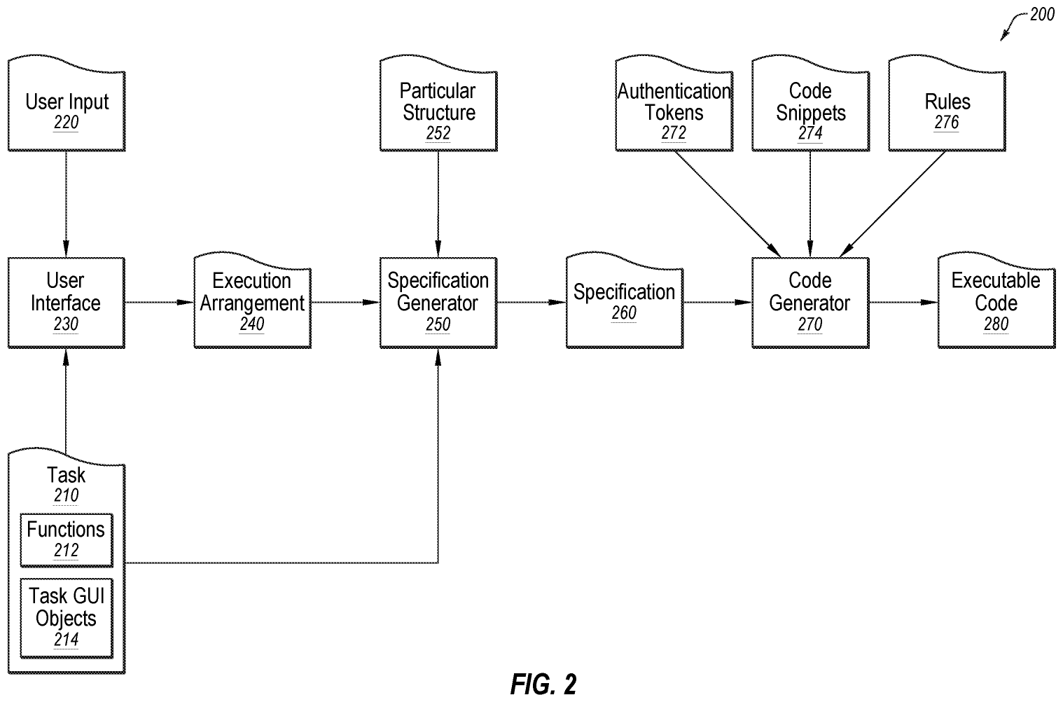

FIG. 2 illustrates an example operational flow 200, according to at least one embodiment in the present disclosure. The operational flow 200 may illustrate an operational flow for task execution. For example, the operational flow 200 may illustrate automatically generating executable code after obtaining multiple tasks and inputs.

The operational flow 200 may include tasks 210, including functions 212 and task graphical user interface (GUI) objects 214, user input 220, a user interface 230, an execution arrangement 240, a specification generator 250, a particular task structure 252, a specification 260, a code generator 270, authentication tokens 272, code snippets 274, rules 276, and executable code 280.

The tasks 210 may include various tasks. For example, the tasks may be analogous to the individual tasks described in the data storage 120 of FIG. 1. The tasks 210 may include functions 212 and be associated with task GUI objects 214. The functions 212 may include making a call to an API or performing one or more function calls. Alternatively or additionally, the functions 212 may include any type of functions. For example, the functions may be analogous to the functions as described associated with the tasks stored in the data storage 120 of FIG. 1.

In some embodiments, the task GUI objects 214 may include a visualization that enables a user to identify the corresponding task 210. The visualization of the task GUI object 214 may include text. The text may be descriptive so as to enable a user to identify the corresponding task 210. For example, a task 210 to obtain calendar events may have a task GUI object 214 with a visualization that reads “Obtain Calendar Events”. Alternatively or additionally, the visualization of the task GUI object 214 may include an icon. The icon may include an image that enables a user to identify the corresponding task 210. For example, a task 210 to create a spreadsheet may have a task GUI object 214 with an icon that looks like a spreadsheet with a star pattern, indicating a new spreadsheet may be created.

The user input 220 may include any user input that enables a user to interact with a user interface. For example, user input 220 may include character input via a keyboard, selecting with a mouse, selecting with touch sensing, dragging and dropping using mouse clicks and movements, etc.

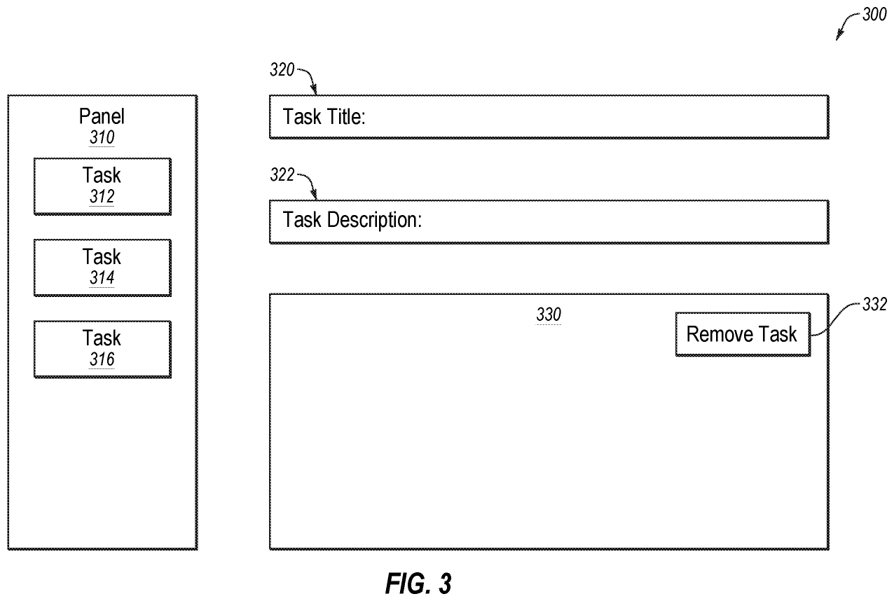

The user interface 230 may accept tasks 210 and user input 220 as inputs. The user interface 230 may display task GUI objects 214 in the alternative or in addition to displaying the tasks 210. The user interface 230 may allow a user, through user input 220, to arrange the tasks 210 using the task GUI objects 214 in the user interface 230. The user interface 230 may produce an output, which may include an execution arrangement 240. An example user interface 230 may be the graphical user interface of FIG. 3.

FIG. 3 illustrates an example graphical user interface 300 for arranging tasks, according to at least one embodiment in the present disclosure. The graphical user interface 300 may illustrate an example interface with which a user may interact to arrange tasks to create an execution arrangement of the tasks.

The graphical user interface 300 may include a panel 310, including a first task GUI object 312, a second task GUI object 314, and a third task GUI object 316, a task title 320, a task description 322, a canvas 330, and a remove task button 332.

The panel 310 may occupy a portion of the graphical user interface 300 and may display various task GUI objects 214 that have been received for display in the graphical user interface 300. In FIG. 3, the received task GUI objects 214 are displayed in the panel 310 as a first task GUI object 312, a second task GUI object 314, and a third task GUI object 316. In some embodiments, there may be more or less than three task GUI objects displayed in the panel 310. Alternatively or additionally, the panel 310 may be resizable in the graphical user interface 300. For example, the panel 310 may have a resize button that may allow a user to select and drag to change the size of the display of the panel 310 in the graphical user interface 300. In these and other embodiments, the panel 310 may include a scroll bar, a slider bar, etc., to allow a user to view task GUI objects that may be more numerous than can be displayed in the panel 310.

In some embodiments, the first task GUI object 312 may be a GUI button that corresponds with a first task, the second task GUI object 314 may be a GUI button that corresponds with a second task, and the third task GUI object 316 may be a GUI button that corresponds with a third task. In these and other embodiments, the first task GUI object 312, the second task GUI object 314, and the third task GUI object 316 may display text that allows a user to identify the corresponding task. For example, the first task GUI object 312 may have the text “Create a Spreadsheet” to indicate a task that creates a spreadsheet. In some embodiments, each of the first task GUI object 312, the second task GUI object 314, and the third task GUI object 316 may also have a description associated with the task. The description associated with the task GUI object may contain additional information as to what function the corresponding task performs. In some embodiments, the description may not be visible until a user interacts with a task GUI object. The description may become visible if a user hovers a mouse cursor over the task GUI object, selects the task GUI object with the mouse cursor, or otherwise interacts with the task GUI object. For example, the first task GUI object 312 may have a description that is not initially visible to a user. If a user hovers the mouse cursor over the first task GUI object 312, a description of the task corresponding to the first task GUI object 312 may be displayed.

In some embodiments, a displayed task in the panel 310 may be an integrated task, such as a result of the operational flow 200. In these and other embodiments, the displayed task may have a task title analogous to task title 320. Alternatively or additionally, the displayed task may have a task description analogous to the task description 322.

The task title 320 may be an input box configured to receive user input from a keyboard. The task title 320 may be the name of the integrated task that is created using the operational flow 200 of FIG. 2. The task description 322 may be an input box configured to receive user input from a keyboard. The task description 322 may be a descriptive identifier for the integrated task that may be created using the operational flow 200 of FIG. 2. For example, an integrated task that adds a row to a spreadsheet and lists all of the rows, may have as the task title 320 “Add spreadsheet row and list all rows.” Continuing with that example, the integrated task may have a task description 322 containing more detail, such as “This task is a combination of a task that adds a blank row to a spreadsheet and a task that lists all of the populated rows in a spreadsheet workbook.”

The canvas 330 may be configured to receive and display task GUI objects that may have been selected for display by a user. In some embodiments, a user may drag and drop task GUI objects from the panel 310 to the canvas 330. For example, a user may select the first task GUI object 312 with a mouse cursor, and while continuing to depress the select button, drag the first task GUI object 312 to the canvas 330 for display. Alternatively or additionally, a user may select a task GUI object, enable a drop-down menu, and may add the task GUI object to the canvas 330. For example, a user may right-click on the second task GUI object 314, after which a drop-down menu may display. From the drop-down menu, the user may choose to add the second task GUI object 314 to the canvas 330. Alternatively or additionally, a hotkey may be assigned to each task GUI object displayed in the panel 310, that when pressed, may add a corresponding task GUI object to the canvas 330. For example, the third task GUI object 316 may have an assigned hotkey. A user may press the hotkey and the third task GUI object 316 may be added to the canvas 330.

The canvas 330 may display task GUI objects that may include the corresponding tasks' inputs and outputs. For example, the first task GUI object 312 may correspond to a task that has one input and one output, and both the input and the output may be displayed in the canvas 330. Alternatively or additionally, the second task GUI object 314 may have two inputs and one output, and the output and both inputs may be displayed in the canvas 330.

In some embodiments, the canvas 330 may be configured to receive user input that enables a user to arrange the task GUI objects. In these and other embodiments, the canvas 330 may be configured to receive user input to connect inputs and outputs from different task GUI objects. For example, the first task GUI object 312, the second task GUI object 314, and the third task GUI object 316 may be added to the canvas 330. After the task GUI objects are added, the canvas 330 may be configured to receive input from a user may to arrange the task GUI objects location in the canvas 330. Continuing the example, the canvas 330 may be configured to receive input from a user to connect the output from the first task GUI object 312 to the input of the second task GUI object 314. The canvas 330 may also be configured to receive input from a user to connect the output from the second task GUI object 314 to the input of the third task GUI object 316.

The remove task button 332 may be any graphically controlled element that is selectable by a user. In some embodiments, the remove task button 332 may be located on the canvas 330. Although the remove task button 332 is illustrated as located on the canvas 330, the remove task button 332 may be located in any location in the graphical user interface 300. The remove task button 332 may enable a user to remove a task from the canvas 330 after the task has been added to the canvas 330. For example, after a user has added the first task GUI object 312 and the second task GUI object 314 to the canvas 330, the user may decide to add the third task GUI object 316 and remove the second task GUI object 314. Continuing with the example, the user may select the second task GUI object 314 and select the remove task button 332 to remove the second task GUI object 314 from the canvas 330.

Referring back to FIG. 2, after the tasks 210 and user input 220 have been input into the user interface 230, an execution arrangement 240 may be generated. In some embodiments, the execution arrangement 240 may define an execution order of a set of the tasks 210 arranged in the user interface 230. The execution arrangement 240 may also define data provided as input to tasks in the execution arrangement 240, data passed between tasks in the execution arrangement 240, and use of data output by tasks in the execution arrangement 240.

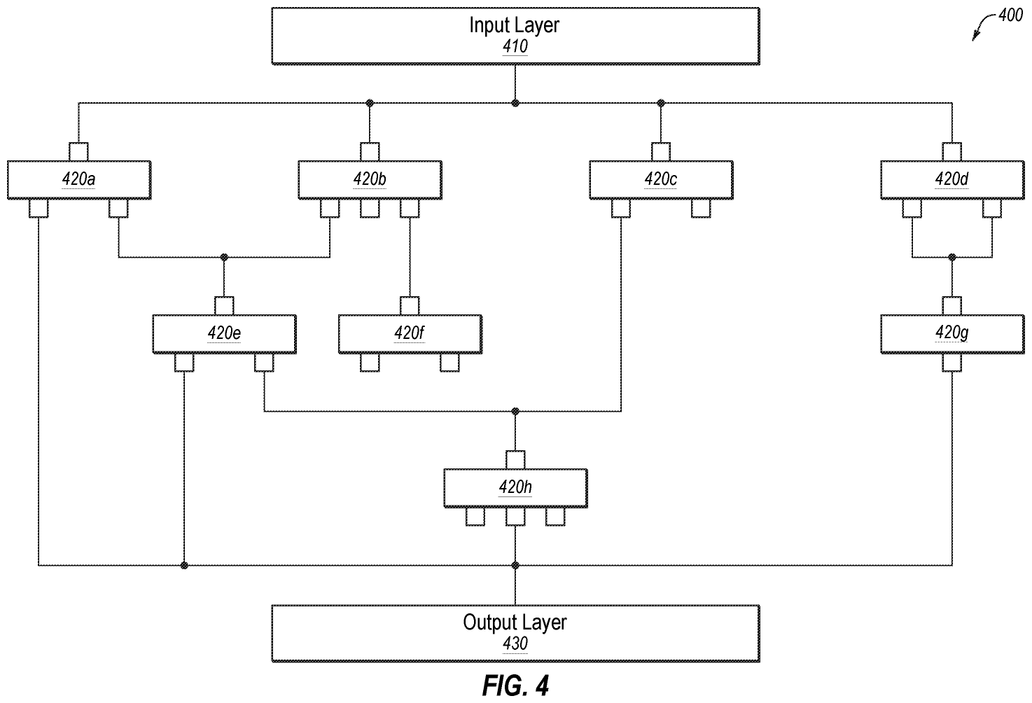

FIG. 4 is a block diagram illustrating a visualization of an example execution arrangement 400 of a set of tasks that forms an integrated task, according to at least one embodiment in the present disclosure. The execution arrangement 400 may illustrate an arrangement of a set of tasks that form an integrated task including inputs, outputs, execution order, and data that may be passed from one task to another task.

The execution arrangement 400 may include an input layer 410, a set of tasks 420, including a first task 420a, a second task 420b, a third task 420c, a fourth task 420d, a fifth task 420e, a sixth task 420f, a seventh task 420g, and an eighth task 420h, and an output layer 430.

The input layer 410 may represent a placeholder for various inputs to the set of tasks 420. In some embodiments, the various inputs may include a constant input, a reference input, and a user input. In some embodiments, a constant input may be a number, a string, a document, a specification, or any other variable that is static at the time a request is made for the input. For example, a saved spreadsheet may be a constant input to a task with a function that returns the number of populated rows in a spreadsheet. In some embodiments, a reference input may be the output of another task in the same execution arrangement. For example, a second task with a function to create columns equal to the number of populated rows may have a reference input, which input is the output of a first task with a function that returns the number of populated rows in a spreadsheet.

In some embodiments, a user input may be an input from a user that is accepted into the system and recognized by the task as valid input. For example, a task may return a specified number of rows in spreadsheet, the number depending on a value requested from a user. Continuing the example, the user input may be restricted to non-zero, natural numbers. In some embodiments, the input layer 410 may include more than one type of the various inputs and may be any combination of the various inputs. For example, a task may use a user input and a reference input, the reference input being the output of another task in the execution arrangement. In some embodiments, a task that is first in the order of execution in the execution arrangement 400 may not have a reference input as the input type.

In some embodiments, the execution arrangement 400 may define an order of execution between the tasks of the set of tasks 420 in an integrated task. As illustrated in FIG. 4, the first task 420a, the second task 420b, the third task 420c, and the fourth task 420d may execute in parallel order, or in overlapping time frames. In these and other embodiments, the fourth task 420d and the seventh task 420g may execute in dependent sequential order. For example, the seventh task 420g may execute after the fourth task 420d executes, as the input for the seventh task 420g is dependent on the output from the fourth task 420d. In these and other embodiments, the first task 420a, the second task 420b, the third task 420c, and the fourth task 420d may execute in independent sequential order. For example, the first task 420a may execute first, the second task 420b may execute second, etc. Although there are no dependencies between first task 420a, second task 420b, third task 420c, and fourth task 420d, the execution arrangement 400 may still determine an execution order between the tasks.

In some embodiments, there may be a combination of parallel execution, independent sequential execution, and dependent sequential execution among the tasks of the set of tasks 420. For example, the first task 420a and the second task 420b may execute in parallel execution and be the first tasks to execute. Continuing the example, the fifth task 420e and the sixth task 420f may also execute in parallel, with respect to the other, and be the second tasks to execute, but both the fifth task 420e and the sixth task 420f may execute in dependent sequential execution, requiring the outputs of the first task 420a and the second task 420b, respectively, before beginning execution. Continuing the example, the third task 420c may execute in independent sequential execution and be the third task to execute. The eighth task 420h may be the fourth task to execute and may execute in dependent sequential execution, requiring the outputs of the third task 420c and the fifth task 420e.

In some embodiments, the execution arrangement 400 may define the inputs of each task of the set of tasks 420, and the data that may be passed between the tasks of the set of tasks 420. In these and other embodiments, the input layer 410 may be input to the first task 420a, the second task 420b, the third task 420c, and the fourth task 420d. In another example, output from the second task 420b may be used as input to the sixth task 420f Alternatively or additionally, data may be passed from multiple task outputs to a single task as input. For example, output from the first task 420a and output from the second task 420b may be jointly passed as an input, such as an input to the fifth task 420e.

The execution arrangement 400 may define what outputs from the tasks of the set of tasks 420 are used and where the outputs from the tasks of the set of tasks 420 are used. For example, the first task 420a may have two outputs, where one output is used as an input to the fifth task 420e and one output is used in the output layer 430. In another example, the second task 420b may have three outputs, where the first output is used as an input to the fifth task 420e, the second output is not used, and the third output is used as an input to the sixth task 420f In another example, the sixth task 420f may have no output. In these and other embodiments, a task may execute a function and not provide an output.

In some embodiments, the output layer 430 may represent a result for various outputs from the tasks of the set of tasks 420. In some embodiments, the output layer 430 may be an output from any of the tasks of the set of tasks 420. For example, an output from the eighth task 420h may be the only output connected to the output layer 430. Alternatively or additionally, the output layer 430 may be a combination of any number of outputs from the tasks of the set of tasks 420. For example, an output from the first task 420a, an output from the fifth task 420e, the output from the seventh task 420g, and an output from the eighth task 420h may all be connected to the output layer 430. In some embodiments, there may be no visual indication to a user related to the output layer 430. For example, the tasks of the set of tasks 420 may all execute and the tasks of the set of tasks 420 may not be connected to the output layer 430.

Referring back to FIG. 2, after the tasks 210 have been arranged in the execution arrangement 240, the result of the execution arrangement 240 may be sent to a specification generator 250. In some embodiments, the tasks 210 and the functions 212 may be inputs to the specification generator 250. Alternatively or additionally, a particular task structure 252 may be an input to the specification generator 250.

In some embodiments, the execution arrangement 240 may include a framework of the arrangement of the tasks 210. In these and other embodiments, the framework of the tasks 210 from the execution arrangement 240 may be combined with the tasks 210 in the specification generator 250.

In some embodiments, the particular task structure 252 may include a placeholder for an automatically generated number which may be used to identify an arrangement of tasks. Alternatively or additionally, the particular task structure 252 may include a placeholder for a task title. For example, the placeholder for the task title of the particular task structure 252 may be filled with user input analogous to the task title 320 of FIG. 3. Alternatively or additionally, the particular task structure 252 may include a placeholder for a task description. For example, the task description placeholder of the particular task structure 252 may be filled with user input analogous to the task description 322 of FIG. 3.

In some embodiments, the particular task structure 252 may include a task chain placeholder. The task chain placeholder of the particular task structure 252 may include an object placeholder for a task. In some embodiments, the task chain placeholder of the particular task structure 252 may include any number of object placeholders. Alternatively or additionally, the task chain placeholder may include an equal number of object placeholders as the number of tasks included in the execution arrangement 240.

In some embodiments, the object placeholder for a task may include a task identification number. The task identification number may be used to identify a specific task among a set of tasks. In some embodiments, the object placeholder for a task may include a chain identification number. The chain identification number may be used to specify the order of execution of a task based on the execution arrangement 240. In some embodiments, every task may have a unique chain identification number. Alternatively or additionally, two different tasks may have the same chain identification number. For example, a first task and a second task that may execute in parallel execution, as determined by the execution arrangement 240, may have the same chain identification number. In some embodiments, the object placeholder for a task may include an input. For example, the input may be analogous to the inputs of the input layer 410 of FIG. 4. In some embodiments, the object placeholder for a task may include an output. For example, the output may be analogous to the outputs of the output layer 430 of FIG. 4.

In some embodiments, after the specification generator 250 has received the tasks 210, the execution arrangement 240, and the particular task structure 252, the specification generator 250 may generate a specification 260. In some embodiments, the specification generator 250 may use the data from the tasks 210 and the execution arrangement 240 to fill the various variables and/or placeholders of the particular task structure 252. For example, the task title placeholder of the particular task structure 252 may be populated with user input in the user interface 230. In another example, the chain identification number of the object placeholder for a task may be populated with an execution order determined from the execution arrangement 240. In another example, the task identification number of the object placeholder for a task may be populated with an identification number unique to an individual task of the tasks 210

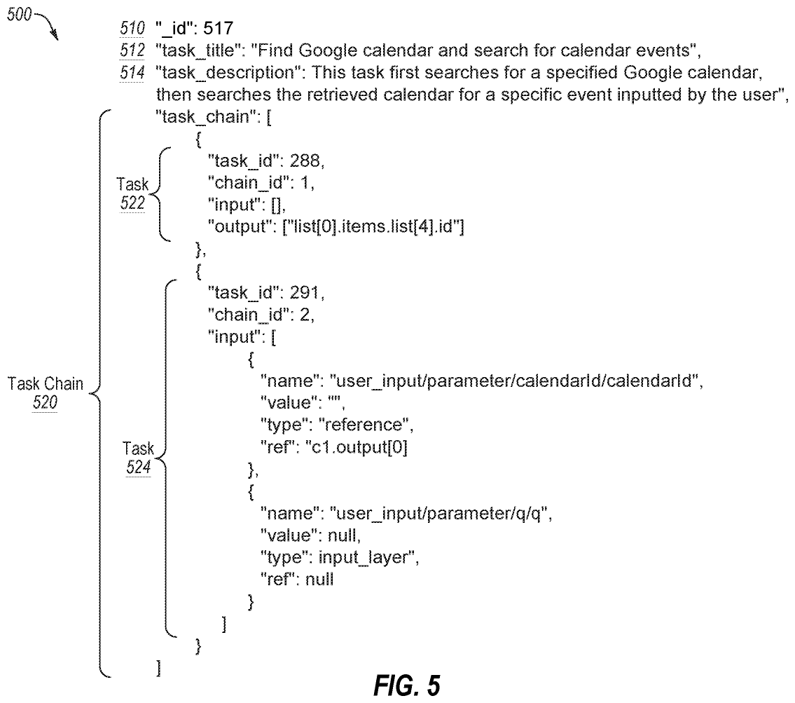

FIG. 5 illustrates an example specification 500 for an execution arrangement of multiple tasks, according to at least one embodiment of the present disclosure. The specification 500 may illustrate an example that may be output by a specification generator and may include a particular task structure.

The specification 500 may include an identification number 510, a task title 512, a task description 514, a task chain 520, a first task 522, and a second task 524.

In some embodiments, the identification number 510 may be automatically generated. In some embodiments, the identification number 510 may be a unique value, when compared to other identification numbers 510 of other specifications 500.

In some embodiments, the task title 512 may include text or a text string. For example, the input to the task title 512 may be analogous to the task title 320 of FIG. 3. In some embodiments, the task title 512 may be used to identify the tasks and functions that may be included in the specification 500. For example, a specification with tasks that perform a search for a calendar and a search for a specific event may have a task title 512 “Find calendar and specific event.”

In some embodiments, the task description 514 may include text or a text string. For example, the input to the task description 514 may be analogous to the task description 322 of FIG. 3. In some embodiments, the task description 514 may be used in conjunction with the task title 512 to further identify the tasks and task functions that may be included in the specification 500. In some embodiments, the task description 514 may include more descriptive text than the task title 512. For example, a specification 500 that includes a task title 512, “Find calendar and specific event” may have a task description 514 of “This task first searches for a specified calendar, then searches the retrieved calendar for a specific event inputted by the user.”

In some embodiments, the task chain 520 may include a first task 522 and a second task 524. Although the task chain 520 displays only two tasks, the task chain 520 may include any number of tasks. In some embodiments, the tasks that may be included in the task chain 520 may include the set of tasks defined in an execution arrangement. For example, for an execution arrangement that includes a first task, a third task, and a fifth task, the task chain 520 may include the first task, the third task, and the fifth task. In some embodiments, the tasks that may be included in the task 520 may be ordered according to the execution order of the execution arrangement.

The first task 522 and the second task 524 may be tasks in the task chain 520. In some embodiments, the first task 522 and the second task 524 may include task identification numbers. The task identification number of the first task 522 may be a unique value when compared to a task identification number of the second task 524. For example, a first task in a task chain 520 may have a first task identification number and a second task in the task chain 520 may have a second task identification number, not equal to the first task identification number. In some embodiments, the first task 522 and the second task 524 may have chain identification numbers. The chain identification number of the first task 522 and the chain identification number of the second task 524 may be used to specify the order of execution of the first task 522 and the second task 524 based on an execution arrangement. In some embodiments, the chain identification number of the first task 522 may be the same as the chain identification number of the second task 524. In some embodiments, the first task 522 and the second task 524 may be ordered in the task chain 520 according to the chain identification number of the first task 522 and the chain identification number of the second task 524.

In some embodiments, tasks in the task chain 520 may have defined inputs. For example, the inputs may be analogous to the inputs of the input layer 410 of FIG. 4. Alternatively or additionally, a task in the task chain 520 may have no input. For example, the first task 522 may not use an input. In the same example, the second task 524 may have a defined input. In some embodiments, an input for a task in the task chain 520 may have a name, a value, a type, and a reference. A name may include a datum name, a file path, etc., that may be used to identify an input. For example, the first input of the second task 524 includes a name “user input/parameter/calendarId/calendarId.” A value may include any constant or static item included as input for a task. For example, a value may include a number, a character, a static file, etc. A type may identify the type of input the task may expect to receive as input. In these and other embodiments, the input for a task may include a constant input, a user input, or a reference input. For example, the first input of the second task 524 has an input type “reference.” Continuing the example, the second input of the second task 524 has an input type of “input_layer,” indicating a user input. In some embodiments, a reference type input may include a pointer to the output of another task. For example, the first input of the second task 524 has a type “reference” and a reference “c1.output[0]” indicating a reference to the first element of the output of the first task 522.

In some embodiments, the output of a first task may be the input of a second task. For example, the specification 500 combines at least two tasks as noted by the title, “Find Google calendar and search for calendar events.” The first task 522 may find a Google calendar and returns the output ‘[“list[0].items.list[4].id”].’ The second task 524 may use the output of the first task 522 to search for calendar events in the calendar returned from the first task 522. The first input of the second task 524 is the reference “c1.output[0]” which is the first element of the output of the first task 522 where the first task 522 is ““'chain_id”: 1” (equivalent to c1 in the second task 524).

Alternatively or additionally, an input for a task in the task chain 520 may have more than one input. In these and other embodiments, a task in the task chain 520 that has more than one input may have one or more of a name, a value, a type, or a reference, or any combination thereof. For example, the second task 524 has a first input with a name, a type defined as a reference, and a reference input, and a second input with a name and a type defined as user input.

In some embodiments, tasks in the task chain 520 may have defined outputs. For example, the outputs may be analogous to the outputs of the output layer 430 of FIG. 4. Alternatively or additionally, a task in the task chain 520 may not have an output. For example, the first task 522 has a defined output. In the same example, the second task 524 has no output. In some embodiments, a task in the task chain 520 may have more than one output. For example, a task with multiple outputs may be analogous to the first task 420a of FIG. 4.

Referring back to FIG. 2, after the specification 260 has been generated, the specification 260 may be sent to a code generator 270. In some embodiments, authentication tokens 272, code snippets 274, and rules 276 may be inputs to the code generator 270. The code generator 270 may be configured to use the specification 260, the authentication tokens 272, the code snippets 274, and the rules 276 to generate executable code 280 of an integrated task.

In some embodiments, tasks in the specification 260 may use the authentication tokens 272 to perform functions associated with the tasks. For example, a task may include a function that makes a call to an API of a remote system. The call to the API may request a user authentication token before access is provided to the API. The authentication tokens 272 may be tokens or references to tokens that may be requested by APIs that are called by tasks identified in the specification 260.

In some embodiments, a user may provide authentication tokens 272 to a system that are provided to the code generator 270. Alternatively or additionally, authentication tokens 272 previously provided to the code generator 270 may be reused. In these and other embodiments, authentication tokens may be used until otherwise revoked. In some embodiments, a user may provide an authentication token 272 for multiple remote systems. For example, an environment analogous to environment 100 of FIG. 1 may have a first remote system that uses an authentication token and a second remote system that uses an authentication token. Alternatively or additionally, a user may provide a unique authentication token 272 for each task in the execution arrangement 240.

In some embodiments, the code snippets 274 may include predefined code that may be used by the code generator 270 to generate the executable code. The code snippets 274 may include generic executable code that may be applicable to many tasks. The code snippets 274 may include supporting code depending on the task input type of tasks that a user may include in the execution arrangement 240. For example, a first code snippet may be used if a task with a constant input is selected by a user to be included in the execution arrangement 240. In another example, a second code snippet may be used if a task with a reference input is selected by a user to be included in the execution arrangement 240. In another example, a third code snippet may be used if a task with a user input is selected by a user to be included in the execution arrangement 240. In some embodiments, the type of the code snippets 274 selected may vary based on a task's number of inputs. Alternatively or additionally, the type of the code snippets 274 selected may vary based on a task's number of outputs.

Alternatively or additionally, the type of the code snippets 274 selected may vary based on the task's order of execution as defined by a user in the execution arrangement 240. In these and other embodiments, the code snippets 274 may be associated with any variables related to the tasks 210, the user input 220, the execution arrangement 240, or the specification 260. In these and other embodiments, the code snippets 274 selected to be used in the code generator 270 may be based on variables included in the execution arrangement 240 as defined by a user. Furthermore, the code snippets 274 may be adjusted to include data stored in the variables of the specification 260 as defined by the particular task structure 252.

In some embodiments, the rules 276 may be used as an input to the code generator 270. The rules 276 may define the implementation of the code snippets 274 in the code generator 270. For example, the rules 276 may implement a first code snippet 274 when a task has a constant input. In another example, the rules 276 may implement a second code snippet 274 when a task has a reference input. In another example, the rules 276 may implement a third code snippet 274 when a task has a constant input and a reference input. Alternatively or additionally, the rules 276 may implement a first code snippet and a second code snippet when a task has a constant input and a reference input. In some embodiments, the rules 276 may be updated as desired by a user.

In some embodiments, the specification 260, that includes the tasks 210, the user input 220, and the execution arrangement 240, may be combined with authentication tokens 272, code snippets 274, and rules 276 by the code generator 270 to automatically generate executable code 280. For example, using the specification 260, the code generator 270 may select code snippets 274 as determined by the rules 276 to generate portions of the executable code that may perform the functionality as defined by the specification 260. For example, a first code snippet may be selected to generate a pointer between a first task output and a second task input. One of the rules 276 may define which one of the code snippets 274 to select based on the type of data being passed between the input and output. In these and other embodiments, the code generator 270 may alter the code snippet at a particular location to include a location of data from the output for the input.

As another example, the code generator 270 may select code snippets from the code snippets 274 to cause the executable code 280 to provide an authentication token of the authentication tokens 272 for a task based on one or more of the rules 276. As another example, the code generator 270 may be configured be selected code snippets from the code snippets 274 for requesting user input to provide to tasks based on one or more of the rules 276.

In some embodiments, the executable code 280 may be automatically generated programming code configured to run on any general-purpose or special-purpose computing device. In some embodiments, the executable code 280 may execute according to the execution arrangement 240 to perform the arrangement of the tasks 210 that are included in the execution arrangement 240 to perform the functions of the integrated task.

In some embodiments, the code associated with the tasks 210 included in the execution arrangement 240 may be imported into the executable code 280. For example, a first task with a function may have code associated with it which may enable the function to execute. The code associated with the first task may be imported to the executable code 280 such that the function of the first task may execute when the executable code 280 is executed. In some embodiments, the executable code 280 may be automatically generated in a target programming language. Alternatively or additionally, the target programming language of the executable code 280 may be determined by a user. For example, the executable code 280 may be automatically generated and configured to run in such programming languages as Python, Java, C, etc., as determined by the user.

In a particular use case, multiple tasks 210 may be available for selection in a user interface 230. After displaying the multiple tasks 210 in the user interface 230, various forms of user input 220 may be employed to select any number of the multiple tasks 210. The selected tasks may be a set of tasks of the multiple tasks 210 and may be added to a canvas of the user interface 230. A user may arrange the set of tasks of the multiple tasks 210, visualized as task GUI objects 214, in the user interface 230. The arrangement may include connecting outputs of some tasks to inputs of other tasks. After the user has completed the arrangement, an execution arrangement 240 of the set of tasks may be defined. The execution arrangement 240 may be used to define variables as defined in the particular task structure 252 to generate a specification 260. The specification 260 may be sent to a code generator 270. In addition to the specification 260, the code generator 270 may also receive authentication tokens 272 as needed for a task 210 included in the execution arrangement 240, and code snippets 274, governed by the rules 276 and the tasks 210 included in the execution arrangement 240. The code generator 270 may use the specification 260, authentication tokens 272, and code snippets 274 to automatically generate the executable code 280 for an integrated task that includes the functions of the set of tasks. The executable code 280 may be configured to perform all of the functions 212 of the set of the tasks 210 that were included in the execution arrangement 240. A user desiring to run the automatically generated executable code 280 on a system may be prompted by the system for one or more inputs for one or more tasks of the set of tasks included in the execution arrangement 240, that may expect user input. In response to the system receiving the user input, the user input may be provided to allow execution of the set of tasks in the integrated task. In response to one or more tasks included in the execution arrangement 240 receiving the user input, the executable code 280 may perform all of the tasks included in the execution arrangement 240.

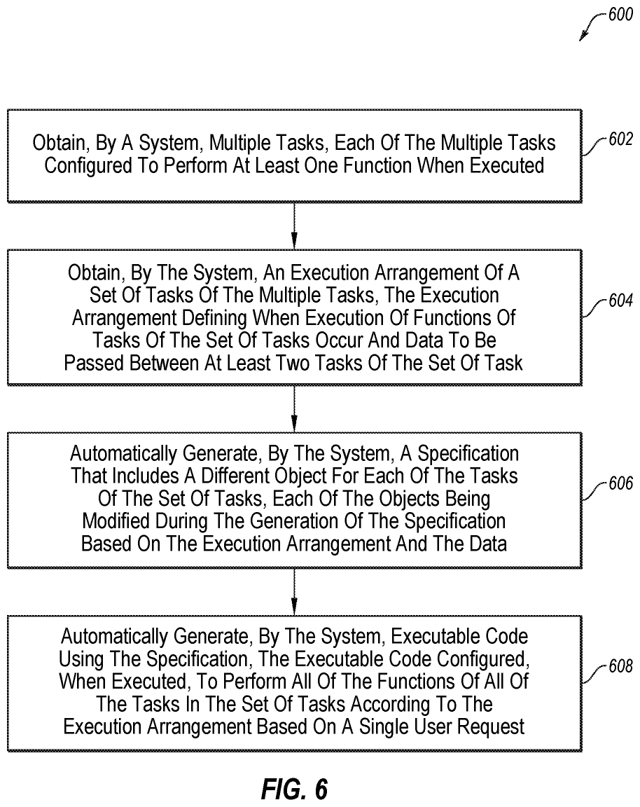

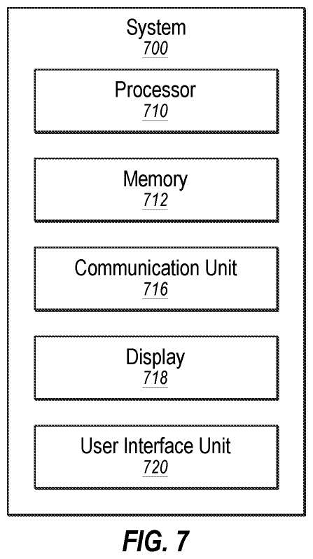

FIG. 6 illustrates a flowchart of an example method 600 of multiple task execution. The method 600 may be arranged in accordance with at least one embodiment described in the present disclosure. One or more operations of the method 600 may be performed, in some embodiments, by a device or system, such as the system 110 of FIG. 1 or the system 700 of FIG. 7 or another device, combination of devices, or system. In these and other embodiments, the method 600 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method may begin at block 602 where multiple tasks may be obtained by a system. The multiple tasks may be configured to perform at least one function when executed. In some embodiments, making a call to an API may be included as one of the functions performed by the multiple tasks.

At block 604, an execution agreement of a set of tasks of the multiple tasks may be obtained by the system. The order of the execution of the set of tasks may be defined by the execution arrangement. Data that may be passed between at least two tasks of the set of tasks may be defined by the execution arrangement. In some embodiments, the execution arrangement may be based on an arrangement of task graphical user interface objects in a graphical user interface. In some embodiments, each of the task graphical user interface objects may correspond to a different task of the set of tasks. In some embodiments, dragging and dropping the task graphical user interface objects into the arrangement may result in the arrangement of task graphical user interface objects.

In some embodiments, a first task that may make a call to a first API of a first remote system may be included in the set of tasks. A second task that may make a call to a second API of a second remote system may be included in the set of tasks. In some embodiments, the first remote system may not be associated with the second remote system. Alternatively or additionally, the first API may not correspond with the second API. In some embodiments, parallel execution of the set of tasks may be included in the execution arrangement configuration. Alternatively or additionally, independent sequential execution of the set of tasks may be included in the execution arrangement configuration. Alternatively or additionally, dependent sequential execution of the set of tasks may be included in the execution arrangement configuration. Alternatively or additionally, any combinations of parallel execution, independent sequential execution, and dependent sequential execution may be included in the execution arrangement configuration.

At block 606, a specification that may include a different object for each task of the set of tasks may be automatically generated by the system. Each of the modifications to the objects during the generation of the specification may be based on the execution arrangement and the data. In some embodiments, the objects may include a particular structure. Variables of the particular structure may be modified based on the execution arrangement. Variables of the particular structure may be modified by the data passed between the tasks of the set of tasks. In some embodiments, the particular structure may include one or more of an identifier of a particular task, an identifier of the arrangement of the particular task in the execution arrangement, one or more variables pointing to output of another task for the particular task to obtain data passed between the particular task and the another task, and one or more variables to obtain an input from a user.

At block 608, executable code may be automatically generated by the system. The executable code may be generated using the specification. Based on a single user request, the executable code may be configured to perform all of the functions of all of the tasks of the set of tasks when executed, according to the execution agreement.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

Modifications, additions, or omissions may be made to FIG. 6 without departing from the scope of the present disclosure. For example, the method 600 may include more or fewer elements than those illustrated and described in the present disclosure. For example, an authentication token for the first task from a remote system that may execute a call to the API that may be from a data storage unassociated with the remote system may be obtained by the method 600 in response to a first task of the set of tasks includes a call to an API that uses authentication.

FIG. 7 is a block diagram illustrating an example system 700 that is arranged to be used in task execution, according to at least one embodiment of the present disclosure. The system 700 may include a processor 710, memory 712, a communication unit 716, a display 718, and a user interface unit 720, which all may be communicatively coupled. In some embodiments, the system 700 may be part of any of the systems or devices described in this disclosure.

For example, the system 700 may be part of the system 110 of FIG. 1 and may be configured to perform one or more of the tasks described above with respect to the system 110. As another example, the system 700 may be part of the first remote system 130, the second remote system 132, or the third remote system 134 of FIG. 1 and may be configured to perform one or more of the tasks described above.

Generally, the processor 710 may include any suitable special-purpose or general-purpose computer, computing entity, or processing device including various computer hardware or software modules and may be configured to execute instructions stored on any applicable computer-readable storage media. For example, the processor 710 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 7, it is understood that the processor 710 may include any number of processors distributed across any number of networks or physical locations that are configured to perform individually or collectively any number of operations described herein. In some embodiments, the processor 710 may interpret and/or execute program instructions and/or process data stored in the memory 712. In some embodiments, the processor 710 may execute the program instructions stored in the memory 712.

For example, in some embodiments, the processor 710 may execute program instructions stored in the memory 712 that are related to task execution such that the system 700 may perform or direct the performance of the operations associated therewith as directed by the instructions. In these and other embodiments, the instructions may be used to perform one or more operations of FIG. 2, or the method 600 of FIG. 6.

The memory 712 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 710.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 710 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 716 may include any component, device, system, or combination thereof that is configured to transmit or receive information over a network. In some embodiments, the communication unit 716 may communicate with other devices at other locations, the same location, or even other components within the same system. For example, the communication unit 716 may include a modem, a network card (wireless or wired), an infrared communication device, a wireless communication device (such as an antenna), and/or chipset (such as a Bluetooth® device, an 802.6 device (e.g., Metropolitan Area Network (MAN)), a WiFi device, a WiMax device, cellular communication facilities, etc.), and/or the like. The communication unit 716 may permit data to be exchanged with a network and/or any other devices or systems described in the present disclosure. For example, when the system 700 is included in the system 110 of FIG. 1, the communication unit 716 may allow the system 110 to communicate with the first remote system 130.

The display 718 may be configured as one or more displays, like an LCD, LED, Braille terminal, or other type of display. The display 718 may be configured to present video, text captions, user interfaces, and other data as directed by the processor 710. For example, when the system 700 is included in the system 110 of FIG. 1, the display 718 may be configured to present the graphical user interface 112 from the system 110.

The user interface unit 720 may include any device to allow a user to interface with the system 700. For example, the user interface unit 720 may include a mouse, a track pad, a keyboard, buttons, camera, and/or a touchscreen, among other devices. The user interface unit 720 may receive input from a user and provide the input to the processor 710. In some embodiments, the user interface unit 720 and the display 718 may be combined.

Modifications, additions, or omissions may be made to the system 700 without departing from the scope of the present disclosure. For example, in some embodiments, the system 700 may include any number of other components that may not be explicitly illustrated or described. Further, depending on certain implementations, the system 700 may not include one or more of the components illustrated and described.

As indicated above, the embodiments described herein may include the use of a special purpose or general-purpose computer (e.g., the processor 710 of FIG. 7) including various computer hardware or software modules, as discussed in greater detail below. Further, as indicated above, embodiments described herein may be implemented using computer-readable media (e.g., the memory 712 of FIG. 7) for carrying or having computer-executable instructions or data structures stored thereon.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
obtaining, by a system, a plurality of tasks, each of the plurality of tasks configured to perform at least one function when executed;
obtaining, by the system, an execution arrangement of a set of tasks of the plurality of tasks, the execution arrangement defining when execution of functions of tasks of the set of tasks occur and data to be passed between at least two tasks of the set of tasks;
automatically generating, by the system, a specification that includes a different object for each of the tasks of the set of tasks, each of the objects being modified during the generation of the specification based on the execution arrangement and the data; and
automatically generating, by the system, executable code using the specification, the executable code configured, when executed, to perform all of the functions of all of the tasks in the set of tasks according to the execution arrangement based on a single user request.

2. The method of claim 1, wherein each of the objects includes a particular structure and variables of the particular structure are modified based on the execution arrangement and the data.

3. The method of claim 2, wherein the particular structure for a particular task of the plurality of tasks includes one or more of an identifier of the particular task, an identifier of the arrangement of the particular task in the execution arrangement, one or more variables pointing to output of another task for the particular task to obtain data passed between the particular task and the another task, and one or more variables to obtain an input from a user.

4. The method of claim 1, wherein the execution arrangement is based on an arrangement of task graphical user interface objects in a graphical user interface where each of the task graphical user interface objects correspond to different task of the set of tasks of the plurality of tasks.

5. The method of claim 4, wherein the arrangement of the task graphical user interface objects in the graphical user interface results from a user dragging and dropping the task graphical user interface objects into the arrangement and the graphical user interface generates the specification.

6. The method of claim 1, wherein in response to a first task of the set of tasks of the plurality of tasks includes a call to an application programming interface that uses authentication, the method further comprises obtaining an authentication token for the first task from a remote system that executes the call to the application programming interface from a data storage unassociated with the remote system.

7. The method of claim 1, wherein the set of tasks of the plurality of tasks includes a first task that makes a call to a first application programming interface of a first remote system and a second task that makes a call to a second application programming interface of a second remote system.

8. The method of claim 7, wherein the first remote system is not associated with the second remote system and the first application programming interface does not correspond to the second application programming interface.

9. The method of claim 1, wherein the execution arrangement is configured to include parallel execution of the set of tasks of the plurality of tasks, independent sequential execution of the set of tasks of plurality of tasks, dependent sequential execution of the set of tasks of plurality of tasks, or combinations thereof.

10. A computer-readable medium comprising computer-executable instructions, which when executed by the system, cause or direct the system to perform the method of claim 1.

11. A system comprising:
at least one computer-readable media configured to store instructions;
at least one processor coupled to the computer-readable media, the at least one processor configured to execute the instruction to cause the processor to perform operations, the operations comprising:
obtain, by a system, a plurality of tasks, each of the plurality of tasks configured to perform at least one function when executed;
obtain, by the system, an execution arrangement of a set of tasks of the plurality of tasks, the execution arrangement defining when execution of functions of tasks of the set of tasks occur and data to be passed between at least two tasks of the set of tasks;
automatically generate, by the system, a specification that includes a different object for each of the tasks of the set of tasks, each of the objects being modified during the generation of the specification based on the execution arrangement and the data; and
automatically generate, by the system, executable code using the specification, the executable code configured, when executed, to perform all of the functions of all of the tasks in the set of tasks according to the execution arrangement based on a single user request.

12. The system of claim 11, wherein each of the objects includes a particular structure and variables of the particular structure are modified based on the execution arrangement and the data.

13. The system of claim 12, wherein the particular structure for a particular task of the plurality of tasks includes one or more of an identifier of the particular task, an identifier of the arrangement of the particular task in the execution arrangement, one or more variables pointing to output of another task for the particular task to obtain data passed between the particular task and the another task, and one or more variables to obtain an input from a user.

14. The system of claim 11, wherein the execution arrangement is based on an arrangement of task graphical user interface objects in a graphical user interface where each of the task graphical user interface objects correspond to different task of the set of tasks of the plurality of tasks.

15. The system of claim 14, wherein the arrangement of the task graphical user interface objects in the graphical user interface results from a user dragging and dropping the task graphical user interface objects into the arrangement.

16. The system of claim 11, wherein in response to a first task of the set of tasks of the plurality of tasks includes a call to an application programming interface that uses authentication, the operations further comprise obtain an authentication token for the first task from a remote system that executes the call to the application programming interface from a data storage unassociated with the remote system.

17. The system of claim 11, wherein the set of tasks of the plurality of tasks includes a first task that makes a call to a first application programming interface of a first remote system and a second task that makes a call to a second application programming interface of a second remote system.

18. The system of claim 17, wherein the first remote system is not associated with the second remote system and the first application programming interface does not correspond to the second application programming interface.

19. The system of claim 11, wherein the execution arrangement is configured to include parallel execution of the set of tasks of the plurality of tasks, independent sequential execution of the set of tasks of plurality of tasks, dependent sequential execution of the set of tasks of plurality of tasks, or combinations thereof.

20. The system of claim 11, wherein the executable code is configured to be generated in a user-defined programming language.
